(19) United States
(12) Patent Application Publication
(10) Pub. No.: US 2007/0277413 A1
(43) Pub. Date: Dec. 6, 2007

(54) BILLBOARD APPARATUS AND ADVERTISING METHOD USING A BILLBOARD APPARATUS

(76) Inventors: Derek Wayne Bailey, Philadelphia, PA (US); Alexandra Bailey, Philadelphia, PA (US)

Correspondence Address: DOVAS LAW P.C., 307 BAINBRIDGE STREET, PHILADELPHIA, PA, 19147, US

(21) Appl. No.: 11/681,172

(22) Filed: Mar. 1, 2007

Related U.S. Application Data
(60) Provisional application No. 60/803,898, filed on Jun. 5, 2006.

(51) Int. Cl. G09F 7/02

(52) U.S. Cl. 40/606.03

(57) ABSTRACT

A billboard apparatus is provided. The billboard apparatus includes a frame, a billboard display connected to the frame for providing information to a user, and a telephone connected to the frame in proximity to the billboard display. A method of advertising using a billboard apparatus is also provided.

### CROSS REFERENCE TO RELATED APPLICATION(S)

This application claims the benefit of U.S. Provisional Application No. 60/803898, filed Jun. 5, 2006, which is incorporated by reference as if fully set forth.

### BACKGROUND

In the fields of marketing and advertising, various attempts are made to cost-effectively increase name recognition and the sale of goods and services. A particular advertisement or advertising campaign may be deemed successful if it results in an increase in name recognition, product sales and revenue, net of advertising costs. The question of whether a specific campaign is effective may be determined by evaluating its effect on customer loyalty, brand name recognition, brand name distribution, etc. Marketing and advertising schemes are created and implemented continually to find the most effective and least costly way of increasing name recognition, sales and revenue.

Display or billboard advertising is widely used because of its ability to reach a huge number of potential customers. Display/billboard advertising is generally limited, however, in the sense that an advertiser cannot accurately gauge the success of a display advertisement. For example, an advertiser may decide to place an advertisement on a billboard located alongside a busy highway or downtown street corner. The return for the advertiser's significant investment is the likelihood that many potential customers will see the billboard each day as they walk or drive past it. From the advertiser's perspective, the mere fact that many people pass the advertisement serves as a basis for the hope that the advertisement is effective. In fact, customers may be preoccupied with other activities and may not even notice the advertisement at all. For instance, a customer may be changing the radio dial in his car or talking to a friend while walking on the street.

A particular advertiser may not, however, have any precise means for estimating how much business is developed due to a particular display advertisement. It may be difficult, for example, to know how many people actually looked at the advertisement. Moreover, it may be difficult to assess how many people, out of all those who see the advertisement, are potential customers for the advertised product or service. With display advertisements, a large percentage of people viewing a particular advertisement may have never used the product or service and/or will never use it despite having seen it advertised. This limitation of display advertisements can be attributed at least in part to the random composition of most advertising audiences.

Advertisements that advertise products or services that are targeted to a particular audience may be more effective. For example, golf club makers may target potential customers at country clubs and public golf courses, whereas wine companies may advertise in liquor stores. Thus, advertisers and marketers often display advertisements to targeted or specialized groups of consumers. [

Further, it appears that a display advertisement is more effective if the same person sees it repeatedly. In that regard, advertisers have implemented various display advertisement schemes wherein an advertisement is appended to a useful item that is kept by a potential consumer for continued reference. For example, it has been suggested to provide a bulk-mail card bearing a display advertisement with useful information printed on a portion of the card, such that its recipient for continued reference would retain the card. A drawback with this system is that it is difficult for the advertiser to assess in advance whether each card recipient will deem the printed information useful. In other words, there is no guarantee that the advertisement will be seen repeatedly by the targeted consumer. Similarly, with respect to known television advertising systems, a targeted potential customer may simply change the channel during the advertisement or be preoccupied with other activities and the advertisement may never be seen enough times or for a sufficient duration to have the desired impact.

Public relation marketing schemes also play a huge role in the efforts of advertisers to reach and influence consumers to remember a brand name or to purchase a product or service. Often, the public relations effort takes the form of providing consumers with positive news reviews about the advertiser or giving the consumer small gifts, i.e. premiums, with the advertiser's logo or brand attached to the gift. In supermarket public relation efforts for example, free samples of food are often given because advertisers believe that when consumers receive something free from a marketer they are more likely to try that advertiser's product or service, as a return of a kind gesture. A drawback with type of advertising is that while the public relations and advertisement gesture might be effective, it is expensive to keep personnel at these locations. If there is no personnel, the display might be ruined or disorganized and therefore create a negative impression rather than a positive impression of the advertised product.

Further, it appears that a display advertisement is more effective if it is seen for an extended duration. In that regard, advertisers have implemented various magazine and catalogue schemes wherein an advertisement is displayed near articles of interest to the consumer in the hope that the consumer is taking a slower pace in reading the articles and the accompanying display advertisement. Advertisers are willing to pay a premium price to advertise in magazines because of their belief that this extended exposure is valuable in terms of better name recognition and sales and revenues. A drawback to this form of advertising is that the advertiser has no way of knowing if the magazine was read at all, or lost or put in the trash. Perhaps it was partially read, but the advertiser never reached the page that the advertiser's ad was on.

Further, advertisers frequently desire to be able to link sales results directly to a particular form of advertising, but this has proved elusive. In that regard, advertisers have implemented various tracking schemes wherein special telephone numbers are only displayed on certain TV commercials or various promotional codes are provided on direct-mail or direct-response advertisements in order that the advertiser can determine from which advertisements specific sales results have been derived. While such tracking is somewhat effective when reaching consumers at home or by mail, it is much more problematic to link sales to a specific advertisement when consumers are in the public domain where the distribution of specific coupons or promotional codes for tracking would be beneficial.

Advertisers must compete for sales in a very competitive marketplace where products of a similar price and quality are available within the same eye space. Therefore, advertisers seek additional qualities and or promotional offers to add to their products to compel consumers to choose their product or service over a competitor's product or service.

In view of the above, there exists a need for a method of advertising that gains the attention of numerous consumers. Further, it would be desirable to provide advertising that offers a public relations premium to attract a consumer to the advertisement. Further, it would be desirable to provide advertising that can dispense a premium where the advertisement is viewed to create goodwill for the advertiser at the point of contact to increase the impact and impression value of the advertisement. It would be desirable that such premium is directly linked to the purchase of a product or service to differentiate that product or service from those of competitors and to track an effectiveness of the promotion. Moreover, there is also a need to provide greater assurance that an advertisement will actually be seen by potential customers, especially considering the duration and repetition required for an advertisement to be effective.

### SUMMARY

The present invention provides a billboard apparatus. The billboard apparatus includes a frame, a billboard display connected to the frame for providing information to a user, and a telephone connected to the frame in proximity to the billboard display.

The present invention further provides a method of advertising. The method of advertising includes providing a billboard apparatus having a billboard display and a premium dispensing device connected to the billboard display. At least one of a free and a reduced priced premium is dispensed using the premium dispensing device, and an advertisement is displayed using the billboard display.

### BRIEF DESCRIPTION OF THE DRAWING(S)

The following detailed description will be readily understood in conjunction with the appended drawings which illustrate preferred embodiments of the invention. In the drawings:

FIG. 1 is a perspective view of a billboard apparatus according to a first preferred embodiment of the invention.

FIG. 2 is a perspective view of the billboard apparatus of FIG. 1 in use by a user, including example displays and shown without a banner arm.

FIG. 3 is a plan view of a preferred installation of the billboard apparatus in front of a plurality of seating assemblies.

FIG. 4 is a flow chart showing an advertising method according to a preferred embodiment of the invention.

### DETAILED DESCRIPTION OF THE PREFERRED EMBODIMENT(S)

Certain terminology is used in the following description for convenience only and is not limiting. The words “right,” “left,” “top,” and “bottom” designate directions in the drawings to which reference is made. The words “a” and “one” are defined as including one or more of the referenced item unless specifically stated otherwise. This terminology includes the words above specifically mentioned, derivatives thereof, and words of similar import. The phrase “at least one” followed by a list of two or more items, such as A, B, or C, means any individual one of A, B or C as well as any combination thereof.

The preferred embodiments of the present invention are described below with reference to the drawing figures where like numerals represent like elements throughout.

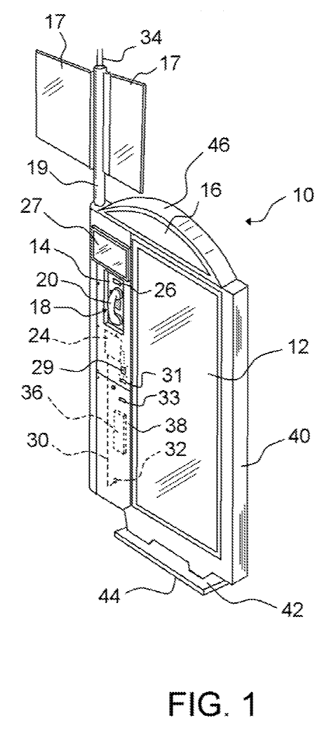

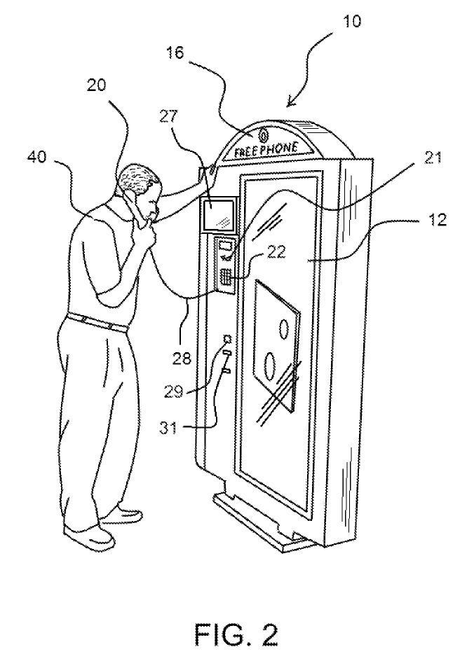

Referring to FIGS. 1 and 2, a billboard apparatus 10 according to a preferred embodiment of the present invention is shown. The billboard apparatus 10 includes a first display 12 for providing information to a user, for example to the user 40 shown in FIG. 2. The billboard apparatus 10 preferably also includes a second display 16. The first and second displays 12, 16 can be of any suitable size and are preferably positioned in any suitable location within a frame 40 of the apparatus 10. A pedestal 42 is preferably provided attached to the frame 40 for mounting the billboard apparatus 10 on a floor. Alternatively, the frame 40 can be configured such that the billboard apparatus can be mounted on a wall, hanging from a ceiling, or mounted in any suitable manner.

A premium dispensing device 14 is provided in proximity to the first and second displays 12, 16 for use by a user. Preferably, at least the first display 12 is sized and positioned such that a user who operates the premium dispensing device 14 can readily view the first display 12. Preferably, the first display 12 is a billboard display at least 2 feet by 3 feet in area allowing it to be viewed from a significant distance away from the billboard apparatus 10. More preferably, the first display 12 is a billboard display at least 3 feet by 5 feet in area. Preferably, the frame 40 and pedestal 42 have a combined height of at least 6 feet measured from a bottom surface 44 of the pedestal to a top surface 46 of the frame 40. Alternatively, displays such as monitors and interactive touch-screens can be provided integral with or in addition to the first and second displays 12, 16. The first display 12, for example, may include an interactive touch screen permitting touch interaction on all or only a portion of the area of the first display 12. Banners 17 are also preferably provided on a banner arm 19 increasing the visibility of the apparatus 10. The banners 17 preferably extend at least two feet above the frame 40. A third display 26 and a fourth display 27 are also preferably provided.

Preferably, the premium dispensing device 14 includes a telephone 18 which permits a user to make telephone calls. The premium dispensing device 14 also preferably includes broadband internet equipment 36 connected to one or more antennas 34 capable of providing free or paid Wi-Fi™ or other RF internet service to locations within view of the billboard apparatus 10. Preferably, the broadband internet equipment 36 is configured to provide a wireless access point operating under at least one of 802.11b, 802.11a and 802.11g wireless standards to provide wireless transmissions with an effective range extending in proximity to the billboard apparatus 10 to permit a plurality of users in proximity to the billboard apparatus 10 to share a broadband internet connection. More preferably, the broadband internet equipment 36 is configured to provide wireless transmissions with an effective range of less than one hundred (100) feet from the billboard apparatus 10. The broadband internet equipment 36 is preferably housed in a maintenance accessible lock box 38 for security.

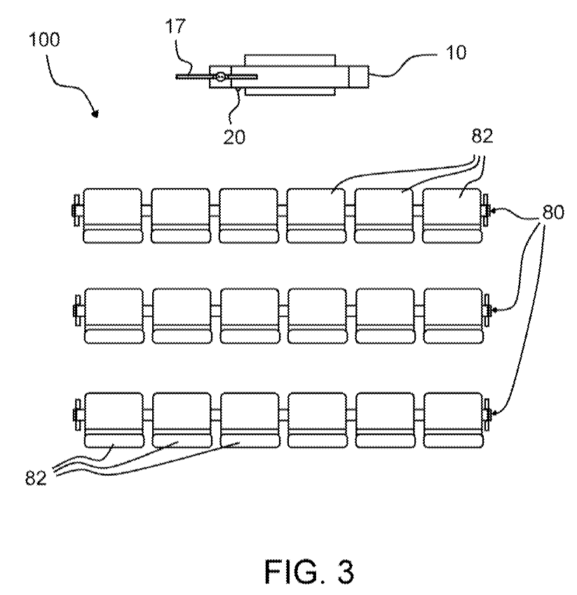

FIG. 3 shows a preferred installation 100 of the billboard apparatus 10, in which a plurality of seat assemblies 80 including seats 82 are arranged in proximity to the billboard apparatus 10 in a seating area. Preferably, the billboard apparatus 10 is positioned within fifty (50) feet of the nearest seat assembly 80. The installation 100 allows people sitting in the seats 82 to view advertisements on the billboard apparatus 10. Preferably, the range of the RF internet service transmission of the billboard apparatus 10 does not substantially exceed the area occupied by the seat assemblies 80. Accordingly, people wishing to utilize the RF internet service will be required to sit in proximity to and facing the billboard apparatus 10 in the seats 82. The seat assemblies 80 may alternatively be arranged in any suitable manner, for example on both sides of the billboard apparatus 10. However arranged, the seat assemblies 80 or any alternative seating assemblies are preferably positioned such that occupants of the seats face the billboard apparatus 10.

The telephone 18 includes a handset 20 positioned on a handset receptacle 21 and an input device 22 to allow a user to enter information, for example a desired telephone number. The handset 20 and the handset receptacle 21 are preferably positioned at least 3 feet from the bottom surface 44 of the pedestal 42. Preferably, the telephone 18 includes a control unit 24 for controlling aspects of a user's telephone call. The control unit 24 is preferably connected to the third display 26, which is preferably an electronic display, for providing a user with additional information for example information pertaining to a phone call or instructions for using the phone. Alternatively, additional controllers in place of or in addition to the control unit 24 may be provided within or external to the billboard apparatus.

The fourth display 27, which is preferably a touch screen video display, is preferably connected to the control unit 24 or a separate control unit for providing additional information, including advertisements, to a user. Preferably the touch screen of the fourth display 27 and the control unit 24 are configured to permit a user to navigate through content, for example television video content, which may be web-based and acquired from a memory in the control unit 24, or alternatively, received from an external source through a line 30 as described below. Alternatively, the fourth display 27 can be provided without user navigational capabilities, and content can be provided only based on scheduling information held in the memory of the control unit 24 or based on scheduling information from an external source through a line 30, for example from a remote server.

The control unit 24 may alternatively also be connected to the first display 12 and/or the second display 16 for controlling operation of the first and/or second displays 12, 16. For example, the control unit 24 may be connected to the first display 12 to control an interactive touch screen directory, integrally formed with the first display 12, used to find vendors, and optionally, to dial contact numbers associated with such vendors in response to a user's touching of the touch screen directory. Such functionality may also be provided to the fourth display 27.

The telephone 18 includes a cord 28 which transmits signals to and from the handset 20. Signals are transmitted to and from the control unit 24 through the line 30 to the connector 32 for connection to an outside signal source. The line 30 may include any suitable cable or multiple cables, for example CAT5/6 and coaxial cable, for linking to an outside telephone or internet connection, for example a connection which provides voice-over-internet-protocol [VOIP] or standard telephone service [POTS]. The handset cord 28 is preferably of sufficiently short length such that a user will be induced to remain in close proximity to the billboard apparatus 10 during phone use. In this manner, a user is more likely to view the first, second, third and fourth displays 12, 16, 26, 27. More preferably the handset cord 28 is approximately between two (2) and three (3) feet in length.

The control unit 24 preferably includes a timer which controls a length of time a user can talk on the telephone 18. The control unit 24 is configured to notify the user via the handset 20 or via one or more of the displays 12, 16, 26, 27 of the amount of time remaining for using the phone. The control unit 24 preferably also includes a memory which stores call information including recently dialed phone numbers and call lengths, and the control unit 24 is preferably configured to prevent calls from being placed to previously dialed phone numbers for a predetermined amount of time. Call information may be used by the control unit 24 to control operation of and/or content appearing on one or more of the displays 12, 16, 26, 27. For example, calls to a certain region can trigger advertising content specific to that region.

The premium dispensing device 14 preferably also includes a scanning device 29, preferably including a bar code reader or other suitable symbol reading device, integrated into the frame 40. A ticket dispenser 31, preferably having printing capabilities, or alternatively any suitable printing device, is also connected to the frame 40. The scanning device 29 and the ticket dispenser 31 are connected to the control unit 24, and the control unit 24 is preferably configured to send a signal to the ticket dispenser 31 to dispense a ticket in response to a signal received from the scanning device 29 indicating that an acceptable symbol has been read.

Tickets or other printed media dispensed from the ticket dispenser 31 may include movie tickets, theater tickets, other entertainment tickets, promotional coupons or any suitable printed information, for example vendor contact information selected by a user through interfacing with the dispensing device 14 or one or more of the displays 12, 16, 26, 27. Accordingly, promotional offers may be offered to a user based on previously purchased products, the products having computer readable labeling, for example barcodes, which can be scanned by the scanning device 29. A user therefore may bring a previously purchased product or such product's label to the billboard apparatus 10, scan the label with the scanning device 29, and receive a ticket or other printed media based on a promotion associated with that product. The control unit 24 preferably records each transaction associated with the dispensing of a ticket such that an advertiser can track which of its product sales may have resulted from that promotion.

Alternatively, the control unit 24 may be configured to dispense a ticket without scanning a barcode or other symbol, but instead based on a user's interaction with the billboard apparatus, for example an interaction with the telephone 18 or the fourth display 27. The premium dispensing device 14 is also preferably provided with a payment receipt device 33 connected to the control unit 24 for optionally receiving credit or cash payment in return for the dispensing of a ticket or other printed media output from the ticket dispenser 31. The premium dispensing device 14 may be connected to an internet-based database or other internal or external data source through the control unit 24. The premium dispensing device 14 may alternatively include other devices in place of or in addition to the telephone 18, broadband internet equipment 36, scanning device 29, ticket dispenser 31 and payment receipt device 33.

The billboard apparatus 10 as described above is useful for inducing a user to stop, and then to stand in front of the billboard apparatus 10 to view one of its displays 12, 16, 26, 27 and banners 17 for an extended duration.

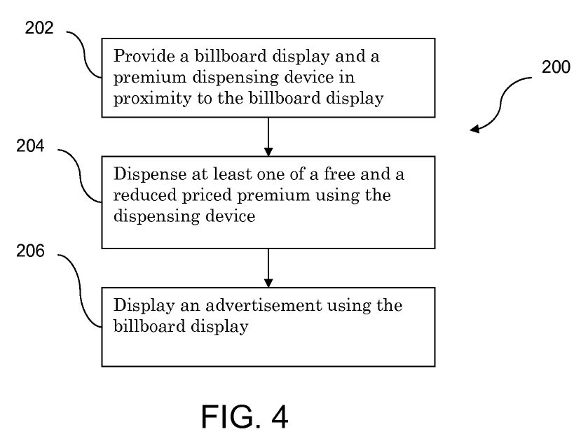

Referring to FIG. 4, an advertising method 200 according to a preferred embodiment of the present invention is shown. The method 200 includes providing a billboard display and a premium dispensing device in proximity to the billboard display (step 202). At least one of a free and a reduced priced premium is dispensed using the dispensing device (step 204). Further, the method 200 includes displaying an advertisement using the billboard display (step 206).

The advertising method 200 preferably utilizes a billboard apparatus, for example the above-described billboard apparatus 10, which dispenses a free or reduced priced premium to induce a user to be positioned in front of the billboard apparatus to view an advertisement in a display of the apparatus. The advertising method 200 preferably further includes locating the apparatus indoor or outdoor in a suitable high consumer traffic area, for example an airport, hospital, school or university, street corner, convenience store or shopping mall The apparatus is preferably located based on a desired demographic. This advertising method 200 can potentially create a valuable public relations gesture by allowing an advertiser to give a free premium in a public setting without the use of personnel, at the point where the advertiser's advertisement is viewed. This method has the potential to generate goodwill for the advertiser's brand and provide a high level of overall effectiveness of the billboard advertisement.

Preferably, the step 204 of providing at least one of a free and reduced priced premium includes providing a telephone allowing a user to make free domestic and international phone calls. Preferably, telephone calling privileges are limited to 10 minutes or less for each particular dialed number. More preferably, free 4 to 7 minute telephone calling privileges are provided to induce potential users to stop and use the phone device, and therefore view the apparatus billboard display. Alternatively, any suitable call length may be permitted. Alternatively, the telephone calls may be restricted to certain domestic or foreign destinations. For example, if the advertisement is directed toward a particular ethnic group, free phone calls to the group's country of origin or other call destinations(s) preferred by that group can be provided. Alternatively, the step 204 may include providing free or paid wireless accessible internet service, for example an internet “hotspot”, in proximity to the billboard apparatus thereby inducing a user to use their computer within sight of the advertisement. Preferably, the wireless accessible internet service provides an advertisements or other sponsor-provided information to a user's wireless compatible device. For example, a link to an opening advertising web page or a “splash page” can be provided, branded for an advertiser, such as the advertiser sponsoring the billboard apparatus, offering an additional level of branding and goodwill, and optionally permitting the advertiser to make offers to a consumer such as targeted coupon offers.

The step 204 may alternatively include providing a redeemable ticket, coupon or other printed media to a user. The redeemable ticket, coupon or other printed media may be provided in response to the scanning of an acceptable label from a previously purchased product, the label being associated with an advertising promotion. The label is preferably scanned by a scanning device provided with the billboard apparatus, and a transaction is recorded to provide the advertiser or advertisers data regarding the effectiveness of the advertising promotion. The redeemable ticket, coupon or other printed media may alternatively be provided in response to a user interaction with the billboard apparatus.

The step 206 of displaying the advertisement preferably includes showing a three by two (3×2) feet or larger advertisement within the apparatus display. The displaying step may additionally or alternatively include using monitors and/or interactive touch-screen directories to show an advertisement. The advertising method 200 is useful to induce a user to view a displayed advertisement for an extended period of time, for example 4 to 7 minutes. This time period compares favorably with the typical 3 to 11 second viewing time given to conventional billboards by consumers. Using TV monitors and/or touch-screen directories can further improve the impression value duration of view time. In the preferred method 200, a user's telephone call activity is recorded, and this information may optionally be used for controlling the content of the displayed advertisement. For example, calls placed to a certain region may result in the display of particular advertisements associated with that region, and in such manner the quality of the number dialed drives the content of the displayed advertisement.

The method 200 may alternatively include providing other advertising or messaging mediums in addition to the advertisement within the apparatus billboard display. An audio message may be provided to a user through the telephone before or after phone use, for example a message indicating the provider of the free phone service, e.g. “this free call is provided to you by the City of New York”. Such a message is potentially useful for further enhancing the impression value of the advertisement.

The advertisement method 200 according to the preferred embodiment of the invention is capable of efficiently reaching a very large number of targeted people repeatedly (and for an extended duration), but yet, is very cost-effective. The method may be employed to provide greater assurance to the advertiser that the advertisement is actually seen by the desired audience.

The method 200 is also useful for efficiently pulling a large number of targeted people to a specific location or venue. For example, if a business wants to attract a particular ethnic group to its store, then that business could provide a billboard apparatus which offers free calls to that group's country of origin or other call destination(s) preferred by that group. Therefore a user would view the advertisement displayed and also be introduced to the products or services offered at the store. As a more specific example, a store offering products or services targeted toward people of Mexican origin could provide a billboard apparatus offering free calls to Mexico within their store to attract their base of customers. In addition, the method 200 may alternatively include positioning a display and a premium dispensing device near a point-of-sale display featuring products geared to a particular ethnic or demographic group to increase the exposure of displayed products to a particular audience. Alternatively, the method 200 may include incorporating a display and a premium dispensing device with a store product display which presents merchandise or other material. The method 200 is capable of increasing sales at store locations because some portion the money saved by making free calls may instead be used for store purchases, for example purchases of candy, cigarettes, coffee, and major food or clothing items noticed by a user of the free telephone.

The method 200 may also include providing a billboard apparatus with an interactive conventional or touch-screen monitor, which is connected to a database over the internet or within the apparatus, and which stores information about local businesses and attractions to provide users with information relevant to the local zip code or region in which the billboard apparatus is located. Once desired information is located by a user on the monitor, a phone call can be made to contacts found which are displayed on the monitor. The user can place the call for example by touching the touch-screen monitor or through use of an input device on the telephone. The method 200 may also alternatively include providing a billboard apparatus wrapped in a graphic skin displaying a brand, colors, logo and/or message of an advertiser. Large BLVD banners including additional advertisements or information may be placed atop the billboard apparatus to improve the visibility of the billboard apparatus and the advertiser's message.

While the preferred embodiments of the invention have been described in detail above, the invention is not limited to the specific embodiments described above, which should be considered as merely exemplary. Further modifications and extensions of the present invention may be developed, and all such modifications are deemed to be within the scope of the present invention as defined by the appended claims.

What is claimed is:

1. A billboard apparatus comprising:
a frame;
a billboard display connected to the frame for providing information to a user; and
a telephone connected to the frame in proximity to the billboard display.

2. The billboard apparatus of claim 1, wherein the billboard display is at least 3 feet by 2 feet in area.

3. The billboard apparatus of claim 1, further comprising a pedestal connected to the frame for mounting the billboard apparatus to a floor surface.

4. The billboard apparatus of claim 1, wherein the frame comprises a substantially vertically oriented structure and the billboard display is substantially vertically oriented on the frame, and wherein the frame and pedestal have a combined height of at least 6 feet.

5. The billboard apparatus of claim 1, further comprising internet equipment configured to provide a wireless access point to provide wireless transmissions.

6. The billboard apparatus of claim 1, wherein the billboard display comprises an interactive touch screen and a control unit connected to the interactive touch screen.

7. The billboard apparatus of claim 1, further comprising at least one banner connected to the frame and extending above the frame.

8. The billboard apparatus of claim 1, wherein the telephone comprises:
a handset; and
a handset receptacle connected to the frame at least three feet from a bottom surface of the billboard apparatus.

9. The billboard apparatus of claim 1, wherein the telephone comprises a control unit including a timer configured to limit a length of time of a phone call, and a control unit display connected to the control unit configured to display an amount of time remaining for a phone call as determined by the control unit.

10. The billboard apparatus of claim 1, wherein the telephone comprises a control unit configured to prevent a previously dialed number from being redialed for a predetermined length of time.

11. A method of advertising comprising:
providing a billboard apparatus comprising a billboard display and a premium dispensing device connected to the billboard display;
dispensing at least one of a free and a reduced priced premium using the premium dispensing device; and
displaying an advertisement using the billboard display.

12. The method of claim 11, further comprising providing the premium dispensing device with a telephone, and dispensing free telephone calls with the telephone.

13. The method of claim 11, further comprising dispensing redeemable tickets using the premium dispensing device.

14. The method of claim 11, further comprising:
providing the premium dispensing device with a telephone;
dispensing free telephone calls with the telephone; and
limiting a length of time which a user can talk on the telephone.

15. The method of claim 11, further comprising:
providing the premium dispensing device with a telephone;
dispensing free telephone calls with the telephone;
limiting a length of time which a user can talk on the telephone;
notifying a user of an amount of time remaining for a telephone call; and
preventing numbers previously dialed with the telephone from being redialed for a predetermined length of time.

16. The method of claim 11, further comprising:
providing the premium dispensing device with a telephone;
dispensing free telephone calls with the telephone;
limiting a length of time to less than 10 minutes for each number dialed with the telephone; and
preventing numbers previously dialed with the telephone from being redialed for a predetermined length of time.

17. The method of claim 11, further comprising:
providing the premium dispensing device with a telephone; and
displaying an advertisement with the billboard display based on a quality of a number dialed by a user using the telephone.

18. The method of claim 11, further comprising:
providing the premium dispensing device with a telephone;
providing the billboard display with an interactive touch screen directory connected to a control unit for displaying a plurality of vendor listings; and
dialing a vendor telephone number, in response to a user selection of a vendor listing with the interactive touch screen, to permit a user to call a vendor with the telephone.

19. The method of claim 11, further comprising:
providing the premium dispensing device with internet equipment configured to provide a wireless access point to provide wireless transmissions; and
positioning the billboard apparatus within proximity of a seating area including a plurality of seats facing the billboard apparatus; and
providing wireless transmissions with the internet equipment with an effective range which does not extend substantially beyond the seating area.

20. The method of claim 11, further comprising:
providing the premium dispensing device with internet equipment configured to provide a wireless access point to provide wireless transmissions; and
positioning the billboard apparatus within 50 feet of a seating area including a plurality of seats facing the billboard apparatus; and
providing wireless transmissions with the internet equipment with an effective range of less than 100 feet.

21. The method of claim 11, further comprising:
providing the premium dispensing device with a scanning device and a ticket dispenser;
scanning with the scanning device a label of a product provided by a user; and
dispensing printed media with the ticket dispenser based on an advertising promotion associated with the product.
